(19) United States
(12) Patent Application Publication
(10) Pub. No.: US 2013/0095211 A1
(43) Pub. Date: Apr. 18, 2013

(54) Emulsions and Food Products Comprising Same and Methods for the Manufacture Thereof

(71) Applicants: Naijie Zhang, Ridgefield, CT (US); William Mutilangi, Peekskill, NY (US)

(72) Inventors: Naijie Zhang, Ridgefield, CT (US); William Mutilangi, Peekskill, NY (US)

(73) Assignee: PepsiCo, Inc., Purchase, NY (US)

(21) Appl. No.: 13/272,286

(22) Filed: Oct. 13, 2011

(51) Int. Cl. A23L 1/30; A23L 1/304; A23L 1/302

(52) U.S. Cl. 426/72; 426/96; 426/99; 426/98; 426/74; 426/602; 426/590; 426/601

(57) ABSTRACT

Sensitive substance-in-wax solutions are disclosed that may be used to protect fish oil and other sensitive edible substances. Sensitive substance wax-in-water emulsions also are disclosed that are stable in food products, e.g., aqueous systems such as acidic beverages, and that may be used to protect sensitive edible substances. The Sensitive substance wax-in-water emulsions can be produced by combining the sensitive substance-in-wax solutions with anionic polymer. Food products comprising the sensitive substance-in-wax solutions and/or the sensitive substance wax-in-water emulsions and methods for producing the sensitive substance-in-wax solutions and the sensitive substance wax-in-water emulsions are also disclosed.

### TECHNICAL FIELD OF THE INVENTION

The present invention relates to the field of protecting a hydrophobic substance from hydrolysis and oxidation, more particularly wax emulsion containing sensitive substances in an aqueous dispersion such as food products.

### BACKGROUND OF THE INVENTION

Certain sensitive substances are desirable as ingredients in food products, such as in, for example, beverages. Such sensitive substances may be hydrophobic substances or hydrophilic substances. In some cases such a hydrophobic substance does not have an acceptable taste or taste profile or is not sufficiently stable in an acidic environment. Examples of such hydrophobic substances include omega-3 fatty acids, water-insoluble flavorants, water-insoluble vitamins, etc. Certain hydrophobic substances have been discovered to have beneficial health effects. For example, omega-3 and omega-6 fatty acids form an important part of the human diet. Eicosapentaenoic acid (EPA) and docosahexaenoic acid (DHA), long-chain forms of omega-3 fatty acids, are understood in many cases to support brain and cardiovascular health and functions, amongst other health benefits. It has been suggested that consumption of omega-3 fatty acids should be increased.

Previously, sensitive substances were incorporated directly into an aqueous system as a solution (with a compatible solvent), an extract, an emulsion, or a micellular dispersion (a so-called microemulsion). While all of these approaches serve to disperse the sensitive substance in an aqueous system, they do not provide extended protection against hydrolysis and oxidation. Commercially available fish oils can be high in omega-3 fatty acids, and in some cases are “encapsulated,” but these commercially available fish oils have not proven adequately stable in all food contexts, e.g., physically or taste-stable in acidic food products. This can result in negative changes to the food product, such as unpleasant fishy flavors and aromas after ingestion, particularly a fishy aftertaste caused by belching fish oil from the stomach. Additionally, omega-3 fatty acids, as well as many water-insoluble flavorants, water-insoluble vitamins, etc. are unstable to degradation, e.g., by oxidation or hydrolysis, when exposed to air, water and/or light.

It would be desirable to provide edible compositions suitable for use in food products, which compositions incorporate one or more sensitive substances in a stable form, e.g., sensitive hydrophobic substances in a form that is shelf stable in an aqueous beverage, syrup, etc. It also would be desirable to provide food products incorporating such edible compositions. At least certain of the embodiments of the new compositions disclosed below can reduce or eliminate the unpleasant taste and odor of the one or more incorporated sensitive substances when used as an ingredient in a food product suitable for consumption by a human or animal. At least certain of the embodiments of the new compositions disclosed below provide sensitive substances in a stable form for use in aqueous systems such as beverages or other food products. In at least some embodiments the sensitive substance is stable to oxidation and hydrolysis during the shelf life of the food product. In at least some embodiments the sensitive substance is stable to oxidation and hydrolysis in an acidic food product, e.g. a food product at pH less than pH 5.0 and in some cases less than pH 3.5. Additional features and advantages of some or all of the food products disclosed here will be apparent to those who are skilled in food technology given the benefit of the following summary and description of exemplary, non-limiting examples.

### SUMMARY

Aspects of the invention are directed to delivery systems for sensitive substances, for example hydrophobic substances, e.g., fish oil, and/or hydrophilic substances, substances prone to oxidation or other degradation when included as an ingredient in a food product, e.g., in a beverage or a beverage concentrate (the latter being alternatively referred to here as a syrup). The delivery systems disclosed here protect or preserve the sensitive substance and in some cases can be itself edible and in some cases suitable for being incorporated into food products, for example, acidic food products. In certain embodiments the sensitive substances are sensitive to acidity, oxygen or other agents or conditions. In certain embodiments the delivery systems provide a mixture of hydrophobic sensitive substances and/or hydrophilic sensitive substances.

In one aspect, sensitive substance wax solutions are provided, that are suitable for consumption as an ingredient in a food product and, in at least certain embodiments, without other ingredients. The sensitive substance wax solutions comprise wax and a sensitive substance protected by the wax. A sensitive substance wax solution in accordance with this aspect of the disclosure can be prepared by providing a wax solution, e.g., melted wax (also referred to here as a melted wax solution), which may be simply liquid wax alone or a liquid mixture or slurry or the like of wax with one or more other ingredients, e.g., diluents, solvents, etc. The sensitive substance, meaning one or more sensitive substances, e.g., a mixture of multiple sensitive substances alone or with one or more other ingredients, e.g., diluents, solvents, etc., is combined with the wax solution. The sensitive substance can be added into the wax solution or they can be otherwise combined. As used in this disclosure, unless otherwise specified, the term “added” or “combined” and like terms means that the multiple ingredients or components (e.g., one or more sensitive substances and a melted wax solution) are combined in any manner and in any order, with or without stirring or the like, with or without heating, etc. For example, one or more ingredients can be dissolved into one or more other ingredients, or sprayed together, etc. Combining the sensitive substance and wax solution forms a sensitive substance wax solution, alternatively referred to here as a wax mixture or a sensitive substance-in-wax solution, which may be a true solution, slurry, suspension, mixture or other form of liquid or flowable material. In certain embodiments, for example, fish oil is mixed with melted natural wax to form a homogenous solution. As used here, the term “homogenous” means commercially adequately homogenous for the intended use, e.g., as a stand-alone consumable or as an ingredient in a beverage or other food product.

In at least certain embodiments, an emulsion is provided having a core-shell capsule structure, wherein the core comprises sensitive substance and the shell comprises wax and anionic polymer, whereby fish oil or other sensitive material is microencapsulated and protected. In at least certain embodiments, a nano solid lipid particle emulsion is provided, wherein the wax component is solid at room temperature. For example, a stable and odourless emulsion of fish oil that is highly dispersible in an acidic beverage can be prepared according to certain exemplary embodiments of this disclosure, by dissolving the fish oil into melted natural wax to form a homogenous solution that is added into a solution of pectin and/or other emulsifier anionic polymer under high mixing to form a nano solid lipid particle emulsion.

In another aspect of the disclosed technology, wax emulsions are provided that are suitable for consumption as an ingredient in a food product and, in at least certain embodiments, “as is,” i.e., without other ingredients. A sensitive substance wax solution as described above is emulsified with at least one anionic polymer emulsifier to form a sensitive substance wax-in-water emulsion, also referred to here as a wax emulsion or a wax oil-in-water emulsion. In at least certain embodiments the emulsion is a nano solid lipid particle emulsion. The emulsions disclosed here can be used as food ingredients. By delivering the sensitive substance(s) into a food product in such emulsion, certain negative effects, e.g., oxidation, off flavor and/or unpleasant aroma, can be reduced or eliminated for at least a period of time, for example, during shipping and storage, e.g., for at least some exemplary embodiments in the form of a beverage having a pH of 3 to 4, for at least 12 weeks. Some exemplary (i.e., non-limiting) examples or embodiments of such emulsions are oil-in-water emulsions. Some embodiments of the emulsions disclosed here can be prepared by mixing melted wax with at least one sensitive substance to form a sensitive substance wax solution and then combining the sensitive substance wax solution with at least one anionic polymer to form a sensitive substance wax-in-water emulsion.

In at least certain embodiments the sensitive substance wax-in-water emulsion is homogenized. For example, it can be agitated at room temperature for a period of time, e.g., from 15 minutes to an hour, e.g., for 30 min. In at least certain embodiments the sensitive substance wax-in-water emulsion is homogenized at high pressure. For example, it can be agitated followed by homogenizing at high pressure, e.g., at 3000 psi to 4000 psi.

In another aspect, food products are provided comprising one or more sensitive substance-in-wax solutions and/or one or more sensitive substance wax-in-water emulsions, as disclosed above, together with one or more other edible ingredients, for example, in some embodiments, one or more nutritional ingredients, e.g., grain component(s), protein, fruit juice or other juice component(s), vegetable juice and/or vegetable component(s), minerals, vitamins, combinations of any of them, etc. As used here, a food product “comprises an emulsion” or “comprises a sensitive substance wax-in-water emulsion” where the food product includes one or more such emulsions together with one or more other food ingredients. The food product comprises such emulsion, as that term is used here, notwithstanding that some or all of the water or other diluent or solvent, and/or other expendable ingredient(s) that the emulsion may originally have had, are not included in the final food product. For example, some or all of the water of the emulsion may be removed prior to, during or after mixing with other ingredients of the food product. In certain exemplary embodiments, the food products are beverages, e.g., fruit juice beverages, carbonated soft drinks etc., wherein the emulsion is from 0.05 weight percent to 3.0 weight percent of the finished beverage, e.g., from 0.1 wt. % to 2.0 wt. % of the finished beverage.

These and other aspects, advantages and features of the present invention herein disclosed will become apparent through reference to the following detailed description. Furthermore, it is to be understood that the features of the various embodiments described herein are not mutually exclusive and exist in various combinations and permutations in other embodiments.

### DETAILED DESCRIPTION OF THE INVENTION

Various examples and embodiments of the inventive subject matter disclosed here are possible and will be apparent to the person of ordinary skill in the art, given the benefit of this disclosure. In this disclosure reference to “some embodiments,” “certain exemplary embodiments” and similar phrases means that those embodiments are merely non-limiting examples of the inventive subject matter and that there likely are other, alternative embodiments which are not excluded. Unless otherwise indicated or unless otherwise clear from the context in which it is described, alternative elements or features in the embodiments and examples below and in the Summary above are interchangeable with each other. That is, an element described in one example may be interchanged or substituted for one or more corresponding elements described in another example. Similarly, optional or non-essential features disclosed in connection with a particular embodiment or example should be understood to be disclosed for use in any other embodiment of the disclosed subject matter. More generally, the elements of the examples should be understood to be disclosed generally for use with other aspects and examples of the devices and methods disclosed herein. A reference to a component or ingredient being operative, i.e., able to perform one or more functions, tasks and/or operations or the like, is intended to mean that it can perform the expressly recited function(s), task(s) and/or operation(s) in at least certain embodiments, and may well be operative to perform also one or more other functions, tasks and/or operations. While this disclosure includes specific examples, including presently preferred modes or embodiments, those skilled in the art will appreciate that there are numerous variations and modifications within the spirit and scope of the invention as set forth in the appended claims. Each word and phrase used in the claims is intended to include all its dictionary meanings consistent with its usage in this disclosure and/or with its technical and industry usage in any relevant technology area. Indefinite articles, such as “a,” and “an” and the definite article “the” and other such words and phrases are used in the claims in the usual and traditional way in patents, to mean “at least one” or “one or more.” The word “comprising” is used in the claims to have its traditional, open-ended meaning, that is, to mean that the product or process defined by the claim may optionally also have additional features, elements, etc. beyond those expressly recited.

As disclosed above, aspects of the invention relate to sensitive substance wax solutions and/or to wax emulsions for delivering, storing and/or protecting edible sensitive substances. For example, emulsions disclosed here can provide a stable composition suitable for inclusion in food products. At least certain embodiments of the wax emulsions disclosed here are stable for shelf-storage and/or for use in making food products, e.g., for shelf-storage when included in acidic food products. At least certain embodiments of the emulsions disclosed here can reduce or eliminate an unpleasant taste or odor of a sensitive substance, such as, e.g., of fish oil, and/or can reduce degradation, e.g., by oxidation or hydrolysis of sensitive substances. Certain embodiments of the emulsions can be incorporated into a food product associated with health benefits, for example into orange juice, sports drinks, near waters and the like, to provide enhanced nutritional value. Additionally, at least some of the wax emulsions may be incorporated into other food products, for example carbonated soft drinks. By encapsulating such sensitive substances in a wax emulsions as disclosed here, negative visual and/or physical changes to the food product may be reduced or avoided for a more appealing food product.

In certain exemplary embodiments, a wax emulsion as disclosed above is provided in an aqueous dispersion. As used here, an aqueous dispersion comprises, consists essentially of, or consists of particles distributed throughout a medium of liquid water, e.g., as a suspension, a colloid, an emulsion, a sol, etc. The medium of liquid water may be pure water or may be a mixture of water with at least one water-miscible solvent or diluent, such as, for example, ethanol or other alcohols, propylene glycol, glycerin, etc. In some exemplary embodiments there may be a substantial concentration of water-miscible solvent in the emulsion, such as, between about 1% and about 20% by volume, for example from 5% to 15% by volume, e.g., from 10% to 15%. In other exemplary embodiments, the wax emulsion is diluted into a food product and the amount or concentration of water-miscible solvent may be negligible.

In some embodiments of the food products disclosed here, essentially all of the sensitive substance is incorporated into the wax emulsion. As used here, “essentially all of the sensitive substance” means that the concentration or amount of the sensitive substance not incorporated into the emulsion is less or lower than the taste or smell threshold for most people in the food product in question. In some other embodiments the aqueous dispersion includes a perceptible concentration of the sensitive substance in addition to the portion incorporated into the emulsion.

In certain exemplary embodiments the “sensitive substance” comprises, consists essentially of, or consists of a water immiscible material, e.g., fish oil or other nutritional oil, a lipid, a water-insoluble vitamin (e.g., α-tocopherol or other tocopherol), a water-insoluble sterol, a water-insoluble flavonoid, a flavor, an essential oil or a combination of any of them. It should be understood that the term “fish oil,” unless stated otherwise, is broad enough to include fish oil comprising other ingredients, e.g., preservatives, diluents, solvents, etc. In other embodiments the “sensitive substance” comprises, consists essentially of, or consists of a water miscible material, e.g., a water-soluble vitamin, a water-soluble sterol, a water-soluble flavonoid, mineral, extracts from plants, herbs, DNA, amino acid, water soluble organic compounds or a combination of any of them. The sensitive substance may be a solid, a liquid or a mixture of both in the emulsions and complex coacervates disclosed here. In some embodiments the sensitive substance is a combination of water immiscible material and water soluble material. As used here the term “lipid” encompasses any substance that contains one or more fatty acid residues, including free fatty acids. Thus, the term “lipid” encompasses, for instance, triglycerides, diglycerides, monoglycerides, free fatty acids, phospholipids or a combination of any of them. As used here the term “fatty acid” encompasses free fatty acids as well as fatty acid residues. Whenever reference is made herein to a weight percentage of fatty acids, this weight percentage includes free fatty acids as well as fatty acid residues (e.g. fatty acid residues contained in triglycerides). Further, as used herein a “polyunsaturated fatty acid” (PUFA) encompasses any fatty acid containing 2 or more double bonds in the carbon chain.

At least some exemplary embodiments of the sensitive substance wax solutions disclosed here can be characterized as having a core-shell capsule structure produced by combining wax with the core substance, i.e., the sensitive substance to be protected. The wax solution (e.g., simply solid or melted wax) mixed or to be mixed with the sensitive substance is heated to a suitable temperature, typically, to a temperature within the range of 30° C. to 150° C., e.g., within the range of 70° C. to 80° C., for at least a period of time long enough to melt or pre-melt the wax. Mixing and/or heating optionally can be continued during forming of the homogeneous wax solution or wax mixture. The duration of mixing and/or heating, if any, in producing the wax mixture will in at least some embodiments depend in part on the solubility of the sensitive substance in the wax. In certain embodiments the resulting wax mixture is an aqueous solution comprising from 0.05 to 5.0 wt. % wax, e.g., from 0.5 to 2.0 wt. % wax.

In exemplary embodiments the wax is a natural wax, for example, bees wax and/or plant wax (i.e., a wax derived from plant material). In certain embodiments the natural wax is selected from the group including, for example, candelilla wax, carnauba wax, palm oil, shellac, fatty acid, fatty acid salts, fatty acid ester, fatty alcohol, fatty triglyceride, lecithin, and combinations of any of them. In certain exemplary embodiments, the natural wax comprises candelilla wax or carnauba wax. In certain exemplary embodiments the wax is a synthetic wax, e.g., a paraffin wax. In some exemplary embodiments the wax and/or resulting wax mixture is solid at room temperature, e.g., at any or alternatively at all temperatures in the range of 20° C. to 25° C.

In certain embodiments an antioxidant is added to the wax with or prior to the addition of sensitive substance(s), e.g., antioxidant selected from butylated hydroxytoluene, butylated hydroxyanisole, tert-butyhydroquinone, quercetin, tocopherol, vitamin C, water soluble polyphenols, water soluble plant extracts (e.g., extracts from herbs, other botanicals or other plants), and combinations of any of them. In certain exemplary embodiments the antioxidant is vitamin C.

In certain embodiments a sensitive substance-in-wax solution comprising melted wax and sensitive substance, e.g., fish oil, as described above, is cooled to room temperature (e.g., 68° F.-75° F., e.g., 70° F., or 20° C.-24° C.). It is currently understood that as the temperature of the wax cools to room temperature the sensitive substance is encapsulated or microencapsulated with the wax, thereby forming wax balls containing the sensitive substance. It is understood that the wax forms a layer that separates the sensitive substance(s) from the environment surrounding the wax ball.

In certain embodiments the sensitive ingredient may be selected from the group including, for example, omega-3 fatty acids, flavor oils, lipophilic nutrients and combinations of any of them. In certain exemplary embodiments the sensitive ingredient is fish oil. In certain embodiments of the sensitive substance wax-in-water emulsions described here, e.g., emulsions formed by dissolving fish oil into melted natural wax, the at least one sensitive substance is present in an amount of 0.1 wt. % to 40 wt. %, e.g., from 1.0 wt. % to 10 wt. % of the sensitive substance wax-in-water emulsion.

In certain exemplary embodiments where the the sensitive ingredient comprises one or more lipophilic nutrients, they may include, for example, fat soluble vitamins, (e.g., vitamins A, D, E, and K), tocotrienols, carotenoids, xanthophylls, (e.g., lycopene, lutein, astaxanthin, and zeazanthin), fat-soluble nutraceuticals including phytosterols, stanols and esters thereof, Coenzyme Q10 and ubiquinol, hydrophobic amino acids and peptides, essential oils and extracts, and fatty acids. Fatty acids may include, for example, conjugated linolenic acid (CLA), omega-6 fatty acids, and omega-3 fatty acids. Suitable omega-3 fatty acids include, e.g., short-chain omega-3 fatty acids such as alpha-linolenic acid (ALA), which are derived from plant sources, for example flaxseed, and long-chain omega-3 fatty acids such as eicosapentaenoic acid (EPA), steradonic acid and docosahexaenoic acid (DHA). The long-chain omega-3 fatty acids can be derived from, for example, marine or fish oils. Such oils can be extracted from various types of fish or marine animals, such as anchovies, capelin, cod, herring, mackerel, menhaden, salmon, sardines, shark and tuna, or from marine vegetation, such as micro-algae, or a combination of any of them. Other sources of omega-3 fatty acids include liver and brain tissue and eggs.

In certain exemplary embodiments where the the sensitive ingredient comprises one or more water-insoluble flavorants, they may include, for example any substance that provides a desired flavor to a food or beverage product, which does not substantially dissolve in water (e.g., non-polar, hydrophobic substances such as lipids, fats, oils, etc.). The flavorant may be a liquid, gel, colloid, or particulate solid, e.g., an oil, an extract, an oleoresin, or the like. Exemplary water-insoluble flavorants include, but are not limited to, citrus oils and extracts, e.g. orange oil, lemon oil, grapefruit oil, lime oil, citral and limonene, nut oils and extracts, e.g. almond oil, hazelnut oil and peanut oil, other fruit oils and extracts, e.g. cherry oil, apple oil and strawberry oil, botanical oils and extracts, e.g., coffee oil, mint oil, vanilla oil, and combinations of any of them.

As disclosed above, in accordance with one aspect of the present disclosure an anionic polymer (meaning at least one and optionally a mixture of anionic polymers) is combined with a sensitive substance-in-wax solution to form the sensitive substance wax-in-water emulsion, also referred to as a wax oil-in-water emulsion. In at least certain exemplary embodiments, homogenizing is used in forming the wax oil-in-water emulsion. The at least one anionic polymer comprises, for example, gum arabic, pectin, modified starches, pectin, Q-200 (available from National Starch), carrageenan, alginate, xanthan gum, modified celluloses, carboxymethylcellulose or carboxyl methyl cellulose (CMC), gum acacia, gum ghatti, gum karaya, gum tragacanth, locust bean gum, guar gum, psyllium seed gum, quince seed gum, larch gum (arabinogalactans), stractan gum, agar, furcellaran, gellan gum, or a combination of any of them. In an exemplary embodiment the anionic polymer is gum arabic. In certain exemplary embodiments, the oil-in-wax solution is added to the emulsifier solution under high-shear mixing conditions to make an oil-in-water emulsion, followed by homogenizing (e.g., at 3000 psi to 4000 psi) to achieve small particle size. In certain embodiments the at least one anionic polymer is present in an amount of 5.0 wt. % to 40.0 wt. % of the final emulsion, e.g., from 10.0 wt. % to 15.0 wt. %.

In certain embodiments a stabilizer is added to the sensitive substance-in-wax solution before the at least one anionic polymer is added. The stabilizer may be selected from sucrose ester, triglycerides, lecithin, ester gum, and combinations of any of them. In an exemplary embodiment the stabilizer is sucrose ester containing triglycerides or ester gum.

It is currently believed that the net negative charge of the anionic polymer is dependent on the pH of the environment and the isoelectric point of the polymer, which is in turn dependent on the density of ionizable groups and the pKa values of those groups. Thus, disclosure here of emulsions comprising anionic polymers refers to the charge of the polymers in the environment or reaction conditions used for formation of the emulsions.

In certain exemplary embodiments, the sensitive substance wax-in-water emulsions comprise, for example, 0.05-10.0 wt. % wax, e.g. 0.5-5.0 wt. %; 0.1-45.0 wt. % of the at least one sensitive substance, e.g. 0.5-30.0 wt. %; and 5.0-45.0 wt. % of the at least one anionic polymer, e.g. 0.5-30.0 wt. %. Optionally, some embodiments comprise 1.0-3.0 wt. % antioxidant and/or 0.1-5.0 wt. % stabilizer, and one or more other ingredients. In certain exemplary embodiments, the emulsions contain, for example, at least 1.0 wt. %, e.g., 8.0 wt. %-12 wt. %, such as 10 wt. %, of one or more polyunsaturated fatty acids selected from omega-3 fatty acids, omega-6 fatty acids and combinations of any of them. In certain embodiments, the one or more polyunsaturated fatty acids are selected from DHA, EPA, CLA, and combinations of any of them.

In certain exemplary embodiments at least a majority of the wax oil-in-water emulsion particles have a volume weighted average diameter in the range of, for example, 0.1-20.0 μm, e.g., from 0.3 μm to 1.5 μm. As used here, the “diameter” is the largest dimension of the particle, and the particle need not be spherical.

In certain exemplary embodiments, the aqueous dispersion of the present invention may contain other dispersed components in addition to the sensitive substance wax-in-water emulsion(s). In certain embodiments, the dispersion contains less than 20 wt. % of one or more dispersed edible components, including the dispersed sensitive substance wax-in-water emulsion(s).

In certain exemplary embodiments, some or all of the sensitive substance wax-in-water emulsion(s) alone or as included in a food product are additionally stabilized, for example by substantial gelling or substantial hardening. In other embodiments the wax emulsion(s) alone or as included in a food product are not substantially additionally stabilized.

In certain exemplary embodiments, the sensitive substance wax-in-water emulsion can be dispersed in water or other aqueous matrix, e.g., as a beverage or a beverage concentrate. The wax emulsion can be maintained as an aqueous dispersion or, in alternative embodiments, can be spray dried, freeze dried, drum dried, or bed dried. If maintained as an aqueous dispersion, optionally it can be treated to inhibit microbiological growth. In certain embodiments, the aqueous dispersion of complex coacervates is, for example, pasteurized, aseptically packaged, treated with chemical preservatives, e.g., sodium benzoate, potassium sorbate, lauric alginate, polylysine, natamycin, velvorin, etc., and/or treated with acid, e.g., citric acid, phosphoric acid, etc. In some exemplary embodiments, the wax emulsion has minimal contact with air during production, is pasteurized after production, and is stored in a refrigerator with limited exposure to light, e.g., sunlight and/or artificial light.

In certain exemplary embodiments, a desired amount of sensitive substance, e.g. fish oil or other hydrophobic substance, is included in a food product as wax emulsion. The amount of wax emulsion, and hence the amount of hydrophobic substance included in the food product may vary depending on the application and desired taste and nutrition characteristics of the food product. The wax emulsion may be added to the food product in any number of ways, as would be appreciated by those of ordinary skill in the art given the benefit of this disclosure. In certain exemplary embodiments, the wax emulsion is sufficiently mixed in the food product to provide a substantially uniform distribution, for example a stable dispersion. Mixing should be accomplished such that the encapsulation of the wax-protected sensitive substance is not destroyed, i.e., is largely left intact. If destroyed, oxidation of the hydrophobic substance may result. Suitable mixer(s) can be selected for a specific application based, at least in part, on the type and amount of ingredients used, the viscosity of the ingredients used, the amount of product to be produced, the flow rate, and the sensitivity of ingredients to shear forces or shear stress.

Encapsulation of sensitive substance, e.g. fish oil or other hydrophobic substances and the like using the above-described wax emulsions can in at least some embodiments stabilize the substance by protecting it from degradation by, for example, oxidation and hydrolysis. When included in an acidic food product, the wax emulsions can provide a stable dispersion of hydrophobic substances over the shelf life of the food product. Factors that may affect shelf-life of a food product comprising one or more of the wax emulsions disclosed here typically include, e.g., the level of processing the product undergoes, the type of packaging, and the materials used for packaging the product. Additional factors that may affect shelf life of the product include, for example, the nature of the base formula (e.g., an acidic beverage sweetened with sugar has a longer shelf-life than an acidic beverage sweetened with aspartame) and environmental conditions (e.g., exposure to high temperatures and sunlight is deleterious to ready-to-drink beverages).

In certain exemplary embodiments, the food products disclosed here comprising one or more of the wax emulsions is a beverage product. In certain embodiments, the beverage products may be a ready-to-drink beverage, a beverage concentrate or syrup, a shelf-stable beverage, a carbonated soft drink, a refrigerated beverage, a frozen beverage, or the like. In some exemplary embodiments, the beverage product is acidic, e.g. having a pH below about pH 5.0, e.g., a pH value within the range of about pH 1.0 to about pH 4.5, or in certain exemplary embodiments, a pH value within the range of about pH 1.5 to about pH 3.8. In an exemplary embodiment the beverage product has a pH of 3.0. Beverage products comprising one or more of the wax emulsions disclosed here include, but are not limited to, e.g., colas, lemon-lime and other carbonated and non-carbonated soft drinks, fountain beverages, liquid concentrates, fruit juice and fruit juice-flavored drinks, sports drinks, energy drinks, fortified/enhanced water drinks such as so called near waters, soy drinks, vegetable drinks, grain-based drinks (e.g. malt beverages), fermented drinks (e.g., yogurt drinks, smoothies, kefir drinks, etc.), coffee beverages, tea beverages, dairy beverages, and mixtures thereof. Exemplary fruit juice sources include citrus fruit, e.g. orange, grapefruit, lemon and lime, berry, e.g. cranberry, raspberry, blueberry and strawberry, apple, grape, pineapple, prune, pear, peach, cherry, mango, and pomegranate. Beverage products include bottle, can, and carton products and fountain syrup applications.

Certain embodiments of other food products comprising one or more of the wax emulsions disclosed here include fermented food products, yogurt, sour cream, cheese, salsa, ranch dip, fruit sauces, fruit jellies, fruit jams, fruit preserves, and the like. In certain exemplary embodiments, the food product is acidic, e.g. having a pH value below about pH 5.0, in certain exemplary embodiments within the range of about pH 1.0 to about pH 4.5, or in certain exemplary embodiments within the range of about pH 1.5 to about pH 3.8. In an exemplary embodiment the food product has a pH of 3.0.

The food products disclosed here may optionally include other, additional ingredients. In certain embodiments such additional ingredients may include, for example, vitamins, minerals, sweeteners, water-soluble flavorants, colorings, thickeners, emulsifiers, acidulants, electrolytes, antifoaming agents, proteins, carbohydrates, preservatives, water-miscible flavorants, edible particulates, and mixtures thereof. In at least some embodiments, the ingredients can be added at various points during processing, including before or after pasteurization, and before or after addition of the wax emulsion(s).

In at least certain exemplary embodiments, food products disclosed here may be pasteurized. The pasteurization process may include, for example, ultra high temperature (UHT) treatment and/or high temperature-short time (HTST) treatment. The UHT treatment includes subjecting the food or beverage product to high temperatures, such as by direct steam injection or steam infusion, or by indirect heating in a heat exchanger. Generally, after the product is pasteurized, the product can be cooled as required by the particular product composition/configuration and/or the package filling application. For example, in one embodiment, the food or beverage product is subjected to heating to about 185° F. (85° C.) to about 250° F. (121° C.) for a short period of time, for example, about 1 to 60 seconds, then cooled quickly to about 36° F. (2.2° C.) +/10° F. (5° C.) for refrigerated products, to ambient temperature for shelf stable or refrigerated products, and to about 185° F. (85° C.) +/−10° F. (5° C.) for hot-fill applications for shelf-stable products. The pasteurization process is typically conducted in a closed system, so as not to expose the food product to atmosphere or other possible sources of contamination. In alternative embodiments, other pasteurization or sterilization techniques may also be useful, such as, for example, aseptic or retort processing. In addition, multiple pasteurization processes may be carried out in series or parallel, as necessitated by the food product or ingredients.

Some food products in accordance with this disclosure optionally may, in addition, be post processed. In exemplary embodiments, post processing is typically carried out following addition of the wax emulsion(s). Post processing can include, for example, cooling the product solution and filling it into a container for packaging and shipping. In certain embodiments, post processing may also include deaeration of the food product to less than 4.0 ppm oxygen, preferably less than 2.0 ppm and more preferably less than 1.0 ppm oxygen. In alternative embodiments deaeration and other post processing tasks may be carried out prior to processing, prior to pasteurization, prior to mixing with the wax emulsion and/or at the same time as adding the wax emulsion. In addition, in certain embodiments, an inert gas (e.g., nitrogen or argon) headspace may be maintained during the intermediary processing of the product and final packaging. Additionally/alternatively, an oxygen or UV radiation barriers and/or oxygen scavengers could be used in the final packaging.

### EXAMPLES

The following examples are specific embodiments of the present invention, but are not intended to limit it.

### Example 1

In a 50 ml round flask with a stirring bar, 0.8 g carnauba wax melted at 86° C. and then 9.4 g (40% EPA/DHA) omega-3 oil was added and mixed until a homogeneous wax solution (“Omega-3 wax solution”) was obtained. The Omega-3 wax solution was added under high shear mixing to 230 g gum arabic solution (20%) containing 6 g ascorbic acid, to form an oil-in-water emulsion in accordance with one embodiment of the sensitive substance wax-in-water emulsions of this disclosure.

### Example 2

In a 50 ml round flask with a stirring bar, 2.0 g candelilla wax melted at 75° C. and then 15 g (22% EPA/DHA) fish oil and 8 g sucrose ester (SAIB-MCT) were added and mixed until an homogeneous wax solution (“Omega-3 wax solution”) was obtained. To 225 g gum arabic solution (20%) containing 0.5 g ascorbic acid the Omega-3 wax solution was added under high shear mixing to form a wax oil-in-water emulsion in accordance with one embodiment of the sensitive substance wax-in-water emulsions of this disclosure. The emulsion was further mixed for 2 minutes at room temperature and then homogenized by 1-2 pass under 3000-4500 psi. Sodium benzoate (0.3 g) was added to the emulsion and pH adjusted 4.00.

### Example 3

In a 50 ml round flask with a stirring bar, 2.0 g candelilla wax melted at 75° C. and then 15 g (22% EPA/DHA) fish oil and 8 g sucrose ester (SAIB-MCT) were added and mixed until a homogeneous wax solution (“Omega-3 wax solution”) was obtained. To 225 g gum arabic solution (20%) containing 1.5 g ascorbic acid the Omega-3 wax solution was added under high shear mixing to form a wax oil-in-water emulsion in accordance with one embodiment of the sensitive substance wax-in-water emulsions of this disclosure.

### Example 4

In a 50 ml round flask with a stirring bar, 3.2 g carnauba wax melted at 86° C. and then 16 g (22% EPA/DHA) fish oil was added and mixed until a homogeneous wax solution (“Omega-3 wax solution”) was obtained. To 225 g gum arabic solution (20%) containing 1.65 g ascorbic acid the Omega-3 wax solution was added under high shear mixing to form an oil-in-water emulsion in accordance with one embodiment of the sensitive substance wax-in-water emulsions of this disclosure.

### Example 5

In a 50 ml round flask with a stirring bar, 9 g palm oil wax melted at 45° C. and then 15 g (22% EPA/DHA) fish oil was added and mixed until homogeneous wax solution (“Omega-3 wax solution”) was obtained. To 225 g gum arabic solution (20%) the Omega-3 wax solution was added under high shear mixing to form an oil-in-water emulsion in accordance with one embodiment of the sensitive substance wax-in-water emulsions of this disclosure.

### Example 6

In a 50 ml round flask with a stirring bar, 3.0 g candelilla wax melted at 75° C. and then 20 g citral was added and mixed until homogeneous wax solution (“citral wax solution”)obtained. To 225 g gum arabic solution (20%) the citral wax solution was added under high shear mixing to form an oil-in-water emulsion in accordance with one embodiment of the sensitive substance wax-in-water emulsions of this disclosure.

### Example 7

In a 50 ml round flask with a stirring bar, 5.0 g candelilla wax melted at 75° C. and then 3.0 g ferrous lactate was added and mixed to form a ferrous lactate wax mixture. To 225 g gum arabic solution (20%) the ferrous lactate wax mixture was added under high shear mixing to form a wax-in-water emulsion in accordance with one embodiment of the sensitive substance wax-in-water emulsions of this disclosure.

### Example 8

In a 50 ml round flask with a stirring bar, 5.0 g candelilla wax melted at 75° C. and then 3.0 g magnesium oxide was added and mixed to form a magnesium oxide wax mixture. To 225 g gum arabic solution (20%) the magnesium oxide wax mixture was added under high shear mixing to form a wax-in-water emulsion in accordance with one embodiment of the sensitive substance wax-in-water emulsions of this disclosure.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

What is claimed is:

1. An emulsion having a core-shell capsule structure, wherein the core comprises sensitive substance and the shell comprises wax and anionic polymer.

2. The emulsion of claim 1 wherein the wax is selected from the group consisting of carnauba wax, candelilla wax, palm oil, shellac and fatty acid, fatty acid ester, fatty alcohol, fatty triglyceride, lecithin, paraffin and combinations of any of them.

3. The emulsion of claim 1 wherein the sensitive substance comprises a hydrophobic substance selected from lipids, water-insoluble vitamins, water-insoluble sterols, water-insoluble flavonoids, flavours, and essential oils and combinations of any of them.

4. The emulsion of claim 1 wherein the sensitive substance comprises a fatty acid selected from an omega-3 fatty acid, an omega-6 fatty acid, and combinations of any of them.

5. The emulsion of claim 1 wherein the sensitive substance is ascorbic acid, ferrous lactate, magnesium oxide, zinc oxide, calcium oxide, extracts from plants, herbs or botanicals, or a combination of any of them.

6. The emulsion of claim 1 wherein the anionic polymer is selected from gum arabic, pectin, xanthan gum, modified cellulose, carrageenan, gum acacia, ghatti gum, xanthan gum, gum karaya, gum tragacanth, locust bean gum, guar gum, psyllium seed gum, quince seed gum, larch gum (arabinogalactans), stractan gum, agar, furcellaran, gellan gum, modified starch, alginate, carboxyl methyl cellulose, and combinations of any of them.

7. The emulsion of claim 1 further comprising antioxidant selected from butylated hydroxytoluene, butylated hydroxyanisole, tert-butyhydroquinone, quercetin, tocopherol, vitamin C, water soluble polyphenols, water soluble plant extracts, and combinations of any of them.

8. The emulsion of claim 1 further comprising a stabilizer selected from sucrose ester, triglycerides, lecithin, ester gum, fatty acids, fatty esters and combinations of any of them.

9. A food product comprising the emulsion of claim 1 and a second food ingredient.

10. A food product comprising an aqueous dispersion of the emulsion of claim 1 and a second food ingredient.

11. An emulsion prepared by:
a. providing a wax solution;
b. forming a sensitive substance wax solution, comprising combining a sensitive substance with the wax solution; and
c. forming a sensitive substance wax-in-water emulsion, comprising combining the sensitive substance wax solution with at least one anionic polymer.

12. The emulsion of claim 11 wherein the wax solution consists essentially of melted wax.

13. The emulsion of claim 11 further comprising adding an antioxidant to the sensitive substance-in-wax solution before combining the anionic polymer with the sensitive substance wax solution.

14. The emulsion of claim 11 further comprising adding a stabilizer to the sensitive substance wax-in-water emulsion.

15. The emulsion of claim 11 wherein the sensitive substance wax solution is at a temperature between 40° C. and 150° C.

16. The emulsion of claim 11 wherein the anionic polymer is combined with the sensitive substance wax solution when both are at room temperature.

17. A food product comprising the emulsion of claim 11 and a second food ingredient.

18. An aqueous dispersion comprising the emulsion of claim 11.

19. A food product comprising an aqueous dispersion of the emulsion of claim 11 and a second food ingredient.

20. The food product of claim 19 wherein the food product is a beverage having a pH of pH 2.5 to pH 5.5.

21. A method for preparing an aqueous dispersion comprising:
a. providing a wax solution;
b. forming a sensitive substance-in-wax solution, comprising combining the wax solution with at least one sensitive substance;
c. forming a sensitive substance-in-wax emulsion, comprising combining the sensitive substance-in-wax solution with at least one anionic polymer; and
d. forming an aqueous dispersion, comprising dispersing the sensitive substance-in-wax emulsion in an aqueous medium.

22. The method for preparing an emulsion of claim 21 further comprising adding an antioxidant to at least one of the sensitive substance-in-wax solution and the anionic polymer before combining the sensitive substance-in-wax solution and the anionic polymer.
